(19) United States
(12) Patent Application Publication
(10) Pub. No.: US 2017/0193764 A1
(43) Pub. Date: Jul. 6, 2017

(54) ELECTRONIC WHISTLE SENSOR WITH MICROCONTROLLER

(71) Applicant: Kevin D'Angelo, Carmel, CA (US)

(72) Inventor: Kevin D'Angelo, Carmel, CA (US)

(21) Appl. No.: 14/986,073

(22) Filed: Dec. 31, 2015

(51) Int. Cl. G08B 5/36; G10K 5/00

(52) U.S. Cl. CPC G08B 5/36; G10K 5/00

(57) ABSTRACT

An improved implementation of the electronic whistle sensor provides more accuracy in determining if the whistle has sounded, utilizes a ubiquitous sensor, and enables versatility in the signaling device.

### CROSS REFERENCE TO RELATED PATENT APPLICATIONS

This application refers to patent application Ser. No. 14/583,680 filed Dec. 27, 2014 by the present inventor.

This application claims the benefit of PPA Ser. No. 62/117,006 filed Feb. 17, 2015 by the present inventor, which is incorporated by reference.

### BACKGROUND OF THE INVENTION

This relates to whistles, specifically to whistles with more functionality than audio generation.

In sporting events such as basketball, the referee blows a whistle to signal various occurrences such as rule violations in real time. Video recordings of games are often consulted, for example, as in the event of a dispute in an instant replay, or at a later time as a study of a previously played game. Often, it is difficult to determine when the whistle was blown because at slow video playback speeds, the whistle recording becomes inaudible. Alternately, crowd noise may interfere with the recording or immediate perception of the whistle sound. A whistle that is illuminated when blown provides an additional perception mechanism well suited to sporting events and video.

In water polo, often, players cannot hear the whistle because they are underwater and thrashing about. Missing a whistle sound affects the real time playing decision making. A whistle that transmits a wireless signal to activate an underwater speaker when blown provides a direct path to the underwater players and can alleviate the missed call problem.

In emergency, wilderness, hunting or maritime situations, it is sometimes difficult to determine the source and direction of a whistle sound. A whistle that lights up when blown provides increased sensory input for these situations.

Hotel personnel utilize a whistle to signal a request for a taxi. An illuminated taxi whistle would allow the taxi driver to pinpoint the location of the request amid the hubbub of people coming and going.

Similar situations where enhanced whistle function is beneficial are, but not limited to, sporting events involving hearing impaired athletes and traffic policing activities. In general, an illuminated whistle would benefit the deaf population as a whole.

The industry standard whistle has no moving parts because moving parts are prone to jamming due in part to excess moisture and thus malfunction during operation. Prior art shows whistle detection schemes that sense air pressure by employing moving diaphragms, mechanical switches and such embedded in the whistle in U.S. Pat. No. 4,314,316 and U.S. Pat. No. 6,181,236. Moving parts and electrical elements combined with moisture are inherently unreliable. Another scheme, in U.S. Pat. No. 5,293,254 utilizes a microphone and a sophisticated electronic receiver to detect sound with a given whistle characteristic. This scheme requires a cumbersome wire leading from the microphone to the receiver unit attached to the user. To avoid false detection, care must be taken to filter interference noise picked up by the microphone from the crowd or an errant non-official whistle. This results in a complicated and bulky receiver attached to the user's belt. These characteristics are all undesirable in a portable system.

None of the above provides a non-mechanical, wireless, secure, lightweight integrated detection solution.

### SUMMARY

A MEMS (MicroElectroMechanical System) based accelerometer IC (Integrated Circuit) provides vibrational information when attached to a whistle. Post processing of the vibrational information can determine whether the vibration was due to the vibrational resonance of the whistle or due to some other source such as shock caused by an impact from another object on the whistle or by dropping the whistle.

In patent application Ser. No. 14/583,680 an accelerometer IC that produces an analog signal corresponding to the vibration is disclosed. There, an analog filter is used to identify the vibration; however, the analog filter is not capable of filtering out non whistle sounding vibrations such as shock. In this application, an accelerometer with a serial digital interface coupled to a microcontroller is disclosed. The microcontroller serves to interpret the data collected by the accelerometer and to selectively activate a signaling device such as a bank of LEDs.

An accelerometer with a digital interface will typically include a FIFO (First In First Out) buffer to hold sampled digitized accelerometer values. An interrupt will generally be available so that the microprocessor can be notified when the accelerometer detects movement above a given threshold. When the microcontroller receives the interrupt signal, it can then read the FIFO data through a serial interface and process the data to determine the source of the interrupt.

The accelerometer responds to stimulus other than the whistle vibrating due to sound. One source is simple movement which generally yields a small perturbation of the accelerometer MEMS structure, which may not result in an interrupt. Another is vibration due to shock from dropping the whistle, or from the lanyard connector striking the whistle during use. A shock will typically yield a large perturbation of the accelerometer MEMS structure and will generate an interrupt. However, the signal generally decays rapidly, and can be differentiated from a sustained whistle sound by analyzing a dataset of the signal taken over time.

To determine if a dataset represents the whistle sound, adjacent samples within the dataset can be compared. If there are enough adjacent samples that differ by a set threshold or greater, related to the magnitude of the whistle vibration signal, the data can be interpreted as a whistle sound. If there are fewer adjacent samples that differ by the threshold, then that sample set can be interpreted to be caused by a source that is not the whistle vibrating due to sound, such as shock.

Once the FIFO data is read and processed, the interrupt is cleared with a serial command from the microcontroller to the accelerometer IC. If the whistle is still emitting sound, the interrupt will recur, the FIFO will fill up and the reading and processing of the data will repeat. This process will continue until the sound ceases.

After the interrupt has been serviced and the FIFO data has been processed, the microcontroller can be placed into a “sleep” mode whereby its power consumption is greatly reduced and battery capacity is preserved. When an interrupt signal is asserted, the microcontroller immediately “wakes” from “sleep” mode and processing begins anew.

A benefit to using a microcontroller to interface with the accelerometer is the enablement of features. For instance, when a whistle is blown, it is often a short burst of sound. In this case, the microcontroller can be used to elongate the signaling feature so that the signaling stays active for a given time after the whistle sound stops. As an example, when a referee blows the whistle, the LEDs used for signaling could stay illuminated for a time after the referee stops blowing the whistle. It is a simple matter for the microcontroller to keep track of elapsed time to generate the elongated signal. This feature is useful because it gives the observer time to look towards the whistle sound and “see” the whistle.

In radio type applications, the microcontroller could use an onboard RF transmission system, such as one used in automobile key fob applications, to signal a nearby device that the whistle is producing a sound. In this manner, a remote scoreboard could automatically stop the clock, or a remote amplifier could produce a sound via underwater speakers.

Other practical features are also enabled with the microcontroller. An example is a test mode to be used during manufacture. A high or low signal can be asserted on one of the input ports of the microcontroller to signify test mode. In test mode, the microcontroller can in turn command the accelerometer to enter into a test mode, which asserts its internal MEMS structure by an electrostatic force, rather than by physical movement of the system, and presents data in accordance with actual movement. When the microcontroller reads the value of that simulated movement, it is interpreted as the accelerometer test mode. The microcontroller can then assert the signaling device, such as the LEDs, for verification of the entire functional chain.

Another example: when a rechargeable battery is employed, the microcontroller can sense, on one of its input ports, if a battery charger has been connected by sensing whether or not the battery charger adapter voltage is present. When the battery charger adapter voltage is sensed, the microcontroller can activate the signaling device (e.g. blinking the LEDs) as feedback to the user. The microcontroller can also take the opportunity to re-initialize the accelerometer, as a safeguard, to prepare for normal operation to follow battery charging, which may otherwise only occur when the battery is installed.

The microcontroller can be in the form of a PIC (Programmable Intelligent Computer). A PIC can be a very small 8-pin integrated circuit that is easily included in a small portable PCB (Printed Circuit Board) that can be attached to a whistle. One benefit of using a PIC is that it can be designed to be programmed in-circuit via an ICSP (In Circuit Serial Programming) mode. With ICSP, the microcode that runs on the PIC can be downloaded onto the flash memory integral to the PIC after the PIC has been installed during manufacture. The benefit of this is the ability to adjust the microcode to accommodate various increased functionality, or to update to new revisions after manufacture. The ICSP method can be found fully documented in the datasheet of a particular PIC.

The ubiquitous 5 volt USB charger can be utilized to charge the battery used to power the whistle sensor. The same USB port can serve double duty and be utilized to accommodate ICSP of the PIC. During charging, care must be taken such that the USB data lines, D+ and D− do not interfere with the PIC operation. One potential hazard is with chargers where D+ and D− are shorted together. Certain chargers are identified by cell phones, for instance, by this direct short. Other cell phones identify a charger having a resistive short between D+ and D−. This is a mechanism to allow the cell phone to identify companion chargers and to charge at full current or not. Samsung products tend to have a short between D+ and D−, while Apple products tend to have D+ and D− connected via a resistor. An issue may arise, for instance, if D+ is connected to a serial interface line for ICSP purposes. When the battery charger is connected, the serial signal can potentially feed back on D−. If D− is connected to an interrupt driven port, the firmware should take this into account and reject those interrupts.

A 5-pin USB micro B connector can serve as the charging port as well as the ICSP port.

### BRIEF DESCRIPTION OF THE DRAWINGS

FIG. 1 is a block diagram showing the accelerometer, PIC, and signaling device connections.

FIG. 2 is a block diagram of the system showing the test mode and charge detect features.

FIG. 3 is a typical accelerometer FIFO dataset when a whistle is sounding.

FIG. 4 is a typical accelerometer FIFO dataset due to whistle shock.

FIG. 5 is a system timing diagram.

### DETAILED DESCRIPTION

Here we describe the connections between the main elements.

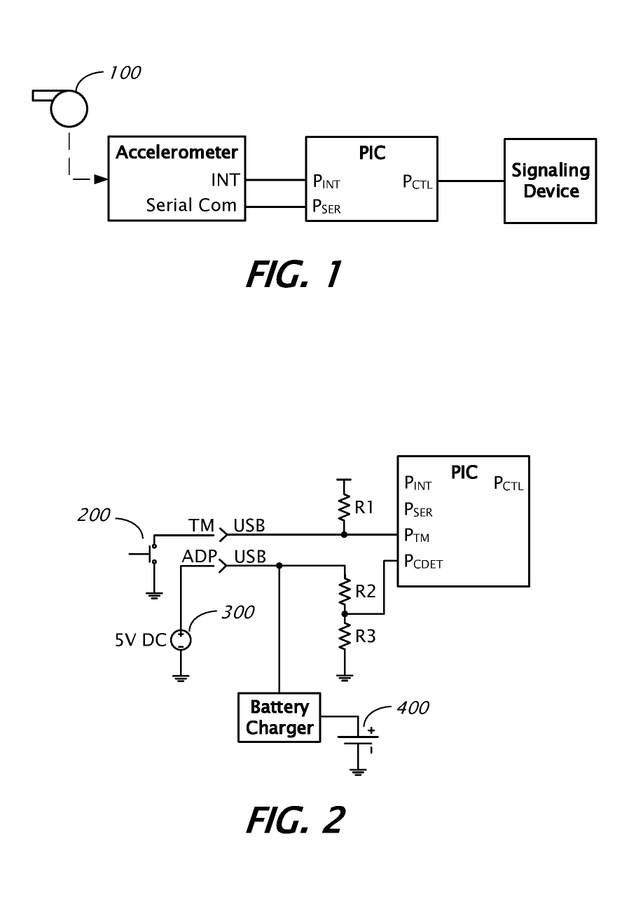

The accelerometer in the block diagram circuit of FIG. 1, attached to whistle 100, records vibrations.

A common accelerometer, the LIS2DH12 from ST Microelectronics, contains a 32 byte FIFO buffer that holds the sampled digitized accelerometer values. The fastest sample rate of 5.376 kHz is chosen to capture the whistle vibration of an industry standard FOX 40 whistle which is in the vicinity of 3.5 kHz. Even though for each vibration cycle there are only approximately 1.5 samples (5.376 kHz/3.5 kHz=1.54), this sample rate suffices for identifying the whistle using a time based method.

When a vibration is of great enough amplitude, the accelerometer sends an interrupt on the INT line to the PIC on one of the PIC external 10 ports shown as P_{INT}. The PIC microcode in turn services the interrupt signal and determines whether the interrupt was due to the whistle sounding. Here, communication between the PIC and the accelerometer is over a standard bidirectional serial interface such as I²C (Inter-Integrated Circuit), which requires 2 wires, or SPI (Serial Peripheral Interface), which requires 3 or 4 wires, shown as P_{SER}. The interrupt source determination is made by employing a short delay; after which the PIC issues a command to the accelerometer to collect 32 samples in the accelerometer FIFO. Once the FIFO has filled with data, the data is analyzed. By identifying local maximum and minimum, the magnitude of each transition can be calculated by subtracting the minimum from the maximum. The sequential difference in samples is also calculated along with the magnitude to determine if the local maximum and minimum are close together. If the magnitude is greater than a threshold, and the samples are close together, then that transition is counted. If there are enough of these transitions, then the sample set is determined to be associated with a whistle sound. If not, it is discarded. If the data is determined to be associated with a whistle sound, the microcode instructs the PIC to activate a signaling device.

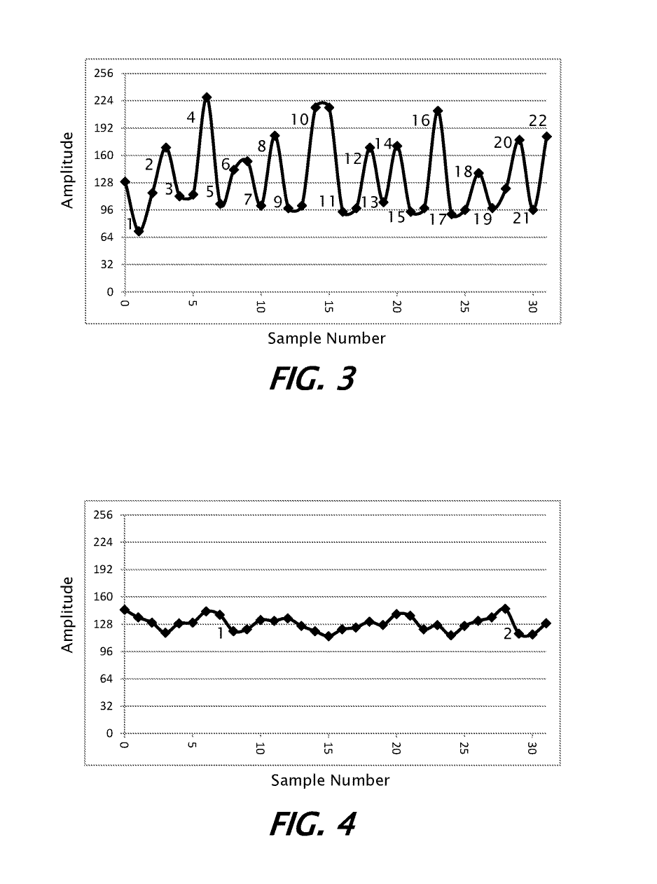

A dataset example is shown in FIG. 3. Here, the sample set is recorded 50 ms after the interrupt has been generated. If a local maximum minus a local minimum is greater than 32, and closer than 3 samples apart, then that transition is counted. If the number of transitions is greater than 7, it is determined to be caused by a whistle sound. In FIG. 3, there are 22 transitions. Each transition is shown by a number in the figure.

FIG. 4 shows a decaying waveform caused by shock, and only two transitions numbered 1 and 2, meet the criteria to count. This dataset would be discarded and no signaling event would occur.

Ideally, the dataset would be analyzed using a form of digital signal processing such as a DFT (Discrete Fourier Transform) which requires a sample rate that is greater than twice the frequency of interest. Since the accelerometer sample rate in this embodiment is less than twice the frequency of the whistle vibration, the DFT contains distortion and the signal cannot be identified. A sample rate of 8 kHz is needed to decipher the 3 kHz to 4 kHz signal produced by the whistle vibration.

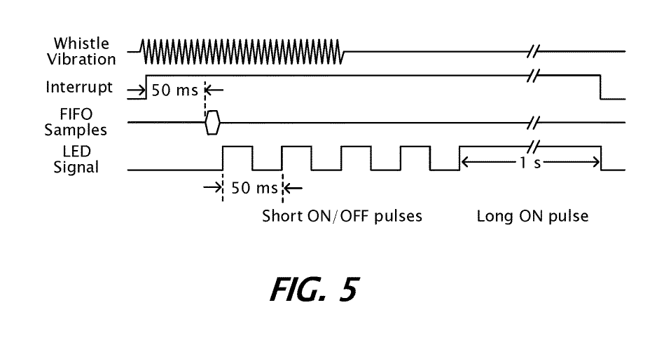

In the case of an LED signaling device, a timed signal can be generated by the PIC microcode. For example, as shown in FIG. 5, the FIFO begins to fill with samples 50 ms after the interrupt is generated due to the start of a whistle vibration. After processing the dataset and determining that the dataset corresponded to a whistle sound, an LED signal consisting of a group of short duration ON pulses followed by a longer ON pulse is generated. In this embodiment, the short pulses have a 50 ms period with a 50% duty cycle, and the long pulse is 1 second in duration. The interrupt is cleared after the signaling is complete.

Additional features shown in FIG. 2 depict a TM (test mode) and a charge detect circuit attached to two USB ports. The Test Mode is implemented with the pullup resistor R1 connected to a port on the PIC, P_{TM}, integral to the circuit attached to the whistle. An external pushbutton switch, 200, serves to short the P_{TM} port to ground when pushed. P_{TM} is configured as an interrupt input by the microcode so that when there is a falling edge on P_{TM}, it is interpreted as Test Mode. Once Test Mode has been determined, the PIC sends a command to the accelerometer that places the accelerometer in test mode. A handshake between the PIC and accelerometer over the serial interface indicates whether the accelerometer is functioning properly or not. If it is functioning properly, the PIC signals this by driving the signaling device ON while the push button is active. Alternatively to pushbutton switch 200, The TM input can be controlled by any external automated test hardware configuration.

A charge detect function is implemented with on-board resistors R2 and R3. These two resistors serve to scale down the battery charger adapter voltage, 300, to be compatible with the PIC supply voltage when the adapter is attached to the system to charge battery, 400. In this embodiment, the 5V DC adapter voltage, 300, is scaled down to 2.8V. The scaled down adapter voltage is connected to the port P_{CDET} on the PIC which is configured as an interrupt. When the adapter is removed, the voltage on port P_{CDET} falls and triggers an interrupt which signifies that charging has ended. To provide a signal to the user that the electronic whistle sensor is alive and well, the interrupt service routine sends a signal to the signaling device. For example, if the signaling device consists of one or more LEDs, the LEDs will blink on and off twice. At this time, the accelerometer is re-initialized as well.

What is claimed is:

1. A system that comprises:
a whistle that produces a sound;
a battery;
a battery charger sub-circuit;
a digital MEMS based accelerometer;
a microcontroller;
wherein said system is configured such that:
the battery charger sub-circuit charges the battery when the whistle is connected to a voltage source; and
the microcontroller and the accelerometer communicate via a serial connection; and
the microcontroller uses data produced by the accelerometer to determine whether or not the whistle is producing a sound.

2. A system as in claim 1 wherein said system is further configured such that the microcontroller can be put in a battery conserving, low power state.

3. A system as in claim 2 wherein said system is further configured such that the microcontroller can be awakened from said low power state via an interrupt from the accelerometer.

4. A system as in claim 1 wherein said system further comprises
one or more lights;
wherein said system is further configured such that
the microcontroller causes the lights to begin emitting a visual signal when the microcontroller determines that the whistle is generating a sound.

5. A system as in claim 4 wherein said visual signal is one or more distinct pulses of light.

6. A system as in claim 1 wherein said system further comprises
an RF transmission subsystem;
wherein said system is further configured such that
the microcontroller causes the RF transmission subsystem to send a signal when the microcontroller determines that the whistle is generating a sound.

7. A system as in claim 1 that further comprises
an external port;
wherein said system is further configured
to detect the charging of the battery when a voltage is detected on the external port and the battery is being charged via the external port.

8. A system as in claim 7 that further comprises
one or more lights;
wherein said system is further configured
to provide a visual indication via said lights when the battery has finished charging.

9. A system as in claim 1 that further comprises
an external connection;
wherein said system is further configured
to communicate with an external system via the external connection.

10. A system as in claim 9 that further comprises
one or more lights;
wherein said system is further configured
such that when a TEST command is received via the external connection, the system executes a self-test, and upon successful completion of said self-test provides a visual indication via the lights.

11. A system as in claim 9 that is further configured such that when a TEST command is received via the external connection, the system executes a self-test, and upon successful completion of said self-test, sends a signal via the external connection.
